(19) United States
(12) Patent Application Publication
(10) Pub. No.: US 2015/0363524 A1
(43) Pub. Date: Dec. 17, 2015

(54) STRESS RELIEF IN A FINITE ELEMENT SIMULATION FOR SPRINGBACK COMPENSATION

(71) Applicant: Ford Global Technologies, LLC, Dearborn, MI (US)

(72) Inventors: Andrey M. ILINICH, Dearborn, MI (US); S. George Luckey, JR., Dearborn, MI (US)

(21) Appl. No.: 14/305,021

(22) Filed: Jun. 16, 2014

(51) Int. Cl. G06F 17/50

(52) U.S. Cl. CPC G06F 17/5018

(57) ABSTRACT

A finite-element-analysis simulator may simulate a pre-bend operation of an object design, performed to a raw material in forming an object, to produce simulated pre-bend results, adjust stress tensor components of the simulated pre-bend results to eliminate residual elastic deformation from the simulated pre-bend results, and complete object simulation of the raw material using the adjusted simulated pre-bend results.

### TECHNICAL FIELD

This disclosure generally relates to improved finite element analysis simulation accounting for relief of bending stress in simulated objects.

### BACKGROUND

Vehicle manufacturers are implementing lighter, stronger materials, such as aluminum alloys, to meet fuel economy goals, reduce manufacturing costs, and reduce vehicle weight while complying with increasingly demanding safety standards. One approach to meeting these competing objectives is to hydroform high strength aluminum alloy into lightweight hydroformed vehicle parts. To establish product feasibility of a hydroformed part design, a designer may simulate a model of the manufacturing process utilizing finite element analysis (FEA).

### SUMMARY

In a first illustrative embodiment, a system includes a memory storing a finite-element-analysis simulator; and a processor configured to execute the finite-element-analysis simulator to simulate a pre-bend operation of an object design, performed to a raw material in forming an object, to produce simulated pre-bend results, adjust stress tensor components of the simulated pre-bend results to eliminate residual elastic deformation from the simulated pre-bend results, and complete object simulation of the raw material using the adjusted simulated pre-bend results.

In a second illustrative embodiment, a computer-implemented method includes simulating, by a hydroforming simulator of raw materials executed by a processing device, a pre-bend operation of an object design performed to a raw material in forming an object, to produce simulated pre-bend results; adjusting, by the hydroforming simulator, stress tensor components of the simulated pre-bend results to eliminate residual elastic deformation from the simulated pre-bend results; and completing the hydroforming simulation using the adjusted simulated pre-bend results.

In a third illustrative embodiment, a non-transitory computer-readable medium stores instructions of a finite-element-analysis simulator, that, when executed by at least one processor, are configured to cause the at least one processor to simulate a pre-bend operation of an object design performed to a raw material in forming an object, to produce simulated pre-bend results; adjust, by the finite-element-analysis simulator, stress tensor components of the simulated pre-bend results to eliminate residual elastic deformation from the simulated pre-bend results; and complete the finite-element-analysis simulation using the adjusted simulated pre-bend results.

### BRIEF DESCRIPTION OF THE DRAWINGS

FIG. 1 illustrates an exemplary system for performing a pre-bending operation of a manufacturing process.

FIG. 2 illustrates an exemplary system for performing finite element analysis with improved pre-bending residual elastic deformation compensation.

FIG. 3 illustrates an exemplary process for performing finite element analysis with improved pre-bending residual elastic deformation compensation.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Hydroforming may be used to manufacture raw material into automotive parts, such as into underbody structural components, roof rails, front rails, and engine cradles. To shape the raw material into the desired part, a hydroforming manufacturing process may perform pre-bending, pre-forming, and hydroforming operations on the raw material. Other manufacturing processes may also include pre-bending steps that are followed by further manufacturing operations.

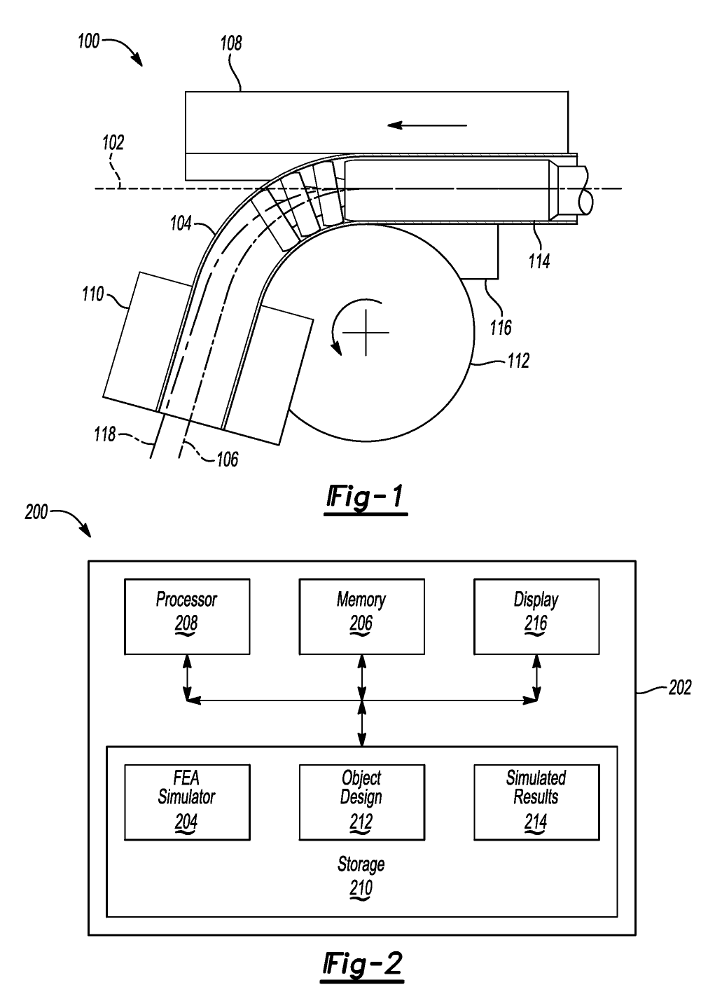

FIG. 1 illustrates an exemplary system 100 for performing a pre-bending operation of a manufacturing process. During the pre-bending operation, a center line 102 of raw material 104 may be adjusted into a shape consistent with a centerline 106 of the resultant part to be formed. In many cases, the raw material 104 may be an aluminum extrusion (e.g., with or without inner walls or webs), but in other cases the raw material 104 may be another ductile metal, such as brass, low alloy steel, or stainless steel. In many cases, the raw material 104 may be tubular or with a relatively circular cross-section to facilitate the forming of the raw material 104 in multiple directions, orientations and angles, but in other examples raw materials 104 having non-circular cross sections may be utilized as well.

In an example, the pre-bending operation may be accomplished using a computer numerical control (CNC) bender performing rotary draw bending (e.g., as illustrated for relatively tighter bends) or push roll bending (e.g., useful for more gentle bends). The bender may include a follower 108 that holds the straight or tangent section of the raw material 104; a clamp 110 that rotates the raw material 104 around a bend die 112; a mandrel 114 to support the tube interior around the bend; and a wiper die 116 that contacts the raw material 104 just before the tangent point of the inside radius, wiping against the raw material 104 to prevent wrinkles that can form on the inside radius of the bend.

The raw material 104 may incur a significant amount of residual elastic deformation (i.e., springback) through the pre-bending operation. As illustrated, exemplary centerline 118 illustrates the centerline of the raw material 104 after an elastic recovery that occurs after unloading of the raw material 104 from the bender. It may be difficult to simulate or otherwise predict an exact amount of residual elastic deformation experienced by the raw material 104, as the amount may vary according to many variables, such as composition and thickness of the raw material 104 and the geometry of the bender tool. Nevertheless, springback may be compensated for during manufacture by specifying an amount of overbending to be performed, such that when the raw material 104 springs back it recovers to the desired angle. While the amount of overbending to use may be difficult to accurately simulate, the amount of overbending may be fine-tuned by a bender machine operator, and readjusted as necessary, such as for new batches of raw material 104.

Once the pre-bending is complete, further manufacturing operations may be performed to the raw material 104. In the case of hydroforming, the pre-forming and hydroforming operations of the hydroforming process may be performed. During the pre-forming, the pre-bent raw material 104 may be altered in form so that it may be properly positioned within a hydroforming die cavity, such as to avoid pinching during closure of the die around the pre-bent raw material 104, or to redistribute matter of the raw material 104 to areas of relatively high local expansion. During the hydroforming, the pre-bent pre-formed raw material 104 may be forced to take the shape of the die cavity by a combined action of internal pressure and axial feeding. For example, the pre-bent pre-formed raw material 104 may be placed in the hydroforming die cavity, and be filled from each end with a liquid at a relatively high level of pressure to shape the pre-bent pre-formed raw material 104 into the shape of the desired part according to the die cavity.

Due to the complexity of manufacturing processes such as the hydroforming process, finite element analysis (FEA) may be utilized to establish product feasibility. FEA is a technique by which numerical solutions to boundary value problems for differential equations are mathematically computed to estimate a response of a physical object or objects subjected to external loads. In FEA, a geometry of an analyzed part to be formed may be discretized, or approximated as a set of points or nodes, that are connected together in a mesh of finite elements. Once discretized, differential equations may be utilized to approximate the object geometry as a set of finite sized matrix equations, where the matrix equations may describe a relationship between the stress, velocity, and acceleration fields at a specific instant in time.

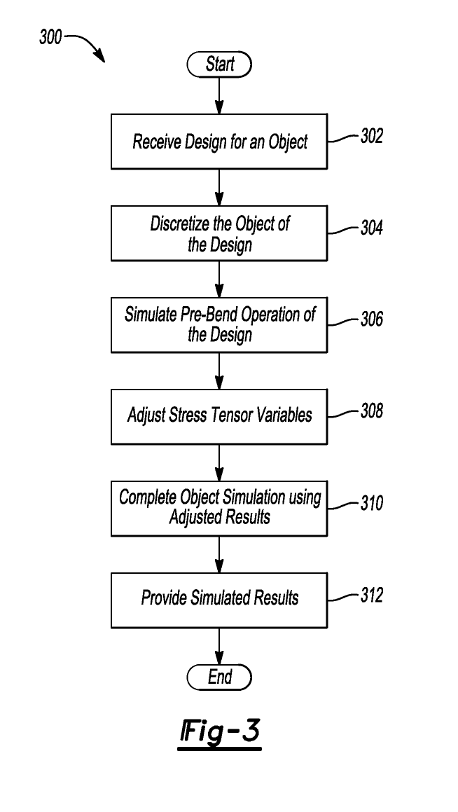

FIG. 2 illustrates an exemplary system 200 for performing FEA for a manufacturing simulation. The system includes a processor device 202 configured to utilize a FEA simulator 204 to receive an object design 212 for a part to be simulated, simulate the pre-bending, simulate any further operations using the object design 212, and determine simulated results 214 indicative of the feasibility and other aspects of the object design 212 as simulated. For a hydroforming process, these further operations may include pre-forming, and hydroforming, or possibly hydroforming without pre-forming. The simulated results 214 may then be stored or displayed to an operator via a display 216.

The processing device 202 may include various types of computing apparatus, such as a computer workstation, a server, a desktop, notebook, laptop, or handheld computer, or some other computing system and/or device. Computing devices, such as processing device 202, generally include a memory 206 on which computer-executable instructions may be maintained, where the instructions may be executable by one or more processors 208 of the processing device 202. Such instructions and other data may be stored using a variety of known computer-readable media. A computer-readable medium 210 (also referred to as a processor-readable medium 210 or storage 210) includes any non-transitory (e. g., tangible) medium that participates in providing data (e.g., instructions) that may be read by a computer (e.g., by the processor 208 of the processing device 202). In general, a processors 208 receives instructions, e.g., from the memory 206 via the computer-readable storage medium 210, etc., and executes these instructions, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Java Script, Perl, PL/SQL, etc.

The FEA simulator 204 may be one application included on the storage 210 of the processing device 202. The FEA simulator 204 may include instructions that, when loaded into memory 206 and executed by the processing device 202, cause the processing device 202 to perform a manufacturing simulation, such as FEA hydroforming simulation, on an object design 212 of a part to be analyzed. More specifically, the FEA simulator 204 may be configured to mathematically model each of the operations for manufacturing a part or other object, in the order they would be performed during manufacture, as specified by the object design 212. For example, the FEA simulator 204 may perform a pre-bending simulation, may apply the output of the pre-bending simulation to a pre-forming simulation, and may apply the output of the pre-forming simulation to a hydroforming simulation, resulting in simulated results 214. As another example, the FEA simulator 204 may perform a pre-bending simulation, and may apply the output of the pre-bending simulation to a hydroforming simulation, resulting in simulated results 214. The simulated results 214 determined by the FEA simulator 204 may then be used to identify issues with parts created according to the object design 212 as simulated, such as areas susceptible to formation of wrinkles, regions for which splitting may be likely, or areas that may experience form and position tolerances in excess of design requirements.

As later stages of the FEA simulation may depend on the results of the earlier stages, errors in earlier stages of the FEA simulation may contribute to wildly inaccurate simulated results 214. One area in which hydroforming FEA approaches fail to accurately model manufacture is with respect to residual elastic deformation calculation during and after the pre-bending operation. Because of differences between simulated and actual springback, there typically exist two bending schedules for an object design 212: a designed bending schedule intended to illustrate an intended part design independent of specific characteristics of the raw material 104 being machined, and a springback-compensated bending schedule that is actually used by the bender accounting for the raw material 104 characteristics.

Some FEA packages may be configured to model according to the bend schedule as designed. Consequently, the simulated part after springback may have incorrect geometrical shape and dimensions. In such packages, rigid constraints may be placed on the part substantially everywhere except for the actual bending zone, preventing the springback during the pre-bending. However, the springback may then be released during the next operation when the constraints are removed, leading to incorrect simulated data for the pre-forming and hydroforming operations, resulting in inaccurate simulated results 214.

In other FEA packages, the springback-compensated bend schedule may be modeled, with a subsequent springback step. However, the springback-compensated bend schedule may fail to account for differences in raw material 104 from batch to batch that typically requires bender operator adjustment. Moreover, FEA predicted springback may still not match actual springback well in many cases, which may cause the FEA simulation to require yet a further springback-compensated schedule to perform the FEA; however, limited tools are available to assist in creation of such a task-specific schedule.

To address these deficiencies, the FEA simulator 204 may be configured to model the pre-bend operation utilizing the as-designed bend schedule of the object design 212, and may impose rigid constraints on the part during those pre-bending operations everywhere except for the actual bending zone. After the pre-bending operation is completed, the FEA simulator 204 may be configured to reset components of the stress tensor for every integration point of every element of the discretized part (e.g., set to zero), effectively eliminating any associated residual elastic deformation in the FEA simulation of the pre-bend operation.

The FEA simulator 204 may be further configured to preserve other element variables of the FEA pre-bend simulation, such as strain tensor and accumulated effective plastic strain components. By performing the remainder of the hydroforming FEA using the adjusted results of the simulation of the pre-bend operation, the FEA simulator 204 may be configured to produce significantly more accurate results and correspondingly shorter simulation turnaround time as compared to other currently used hydroforming FEA simulation approaches.

FIG. 3 illustrates an exemplary process 300 for performing FEA with adjusted post-bending residual elastic deformation. The process 300 may be performed, for example, by the FEA simulator 204 executed by the processing device 202 to perform a hydroforming simulation.

At operation 302, the FEA simulator 204 receives an object design 212 for use in forming raw material 104 into a manufactured object. The object may be, for example, an automotive component or part such as an underbody structural components, roof rail, front rail, or engine cradle. The raw material 104 may be, for example, a tubular aluminum extrusion. The object design 212 may include an actual bend schedule specifying bends to be performed on the raw material 104, as well as information indicative of further manufacturing operations to be performed post-bending, such as pre-forming and hydroforming operations to be performed in sequence to form the raw material 104 into the desired object.

At operation 304, the FEA simulator 204 discretizes the object specified by the object design 212. For example, the FEA simulator 204 may be configured to approximate a geometry of the object as a set of points or nodes that are connected together in a mesh of finite elements.

At operation 306, the FEA simulator 204 simulates a pre-bend operation of the object design 212. The pre-bend operation may include one or more bending steps. For example, the FEA simulator 204 may utilize FEA to compute information such as stresses, strains, and accumulated plastic strains at each element of the finite element mesh according to an actual bend schedule of the object design 212.

At operation 308, the FEA simulator 204 adjusts the stress tensor components of the simulated pre-bend results to eliminate post-bending residual elastic deformation. For example, the FEA simulator 204 may be configured to reset the components of the stress tensor for every integration point of every element of the discretized part (e.g., set to zero), effectively eliminating any associated residual elastic deformation in the FEA simulation of the pre-bend operation.

At operation 310, the FEA simulator 204 completes simulation of the object design 212. For example, the FEA simulator 204 may perform FEA on the adjusted simulated pre-bend results determined in operation 308 to simulate the geometrical shape, stresses, and strains resulting from any pre-forming operations performed to the pre-bent raw material 104 according to the object design 212. These simulated operations may include alterations performed to allow the raw material 104 to be properly positioned within the hydroforming die cavity, such as to avoid pinching during closure of the die around the pre-bent tube, or to redistribute material to areas of relatively high local expansion. The FEA simulator 204 may further simulate a hydroforming operation of the object design 212. For example, the hydroforming simulator may perform FEA on the simulated pre-forming results determined in operation 310 to simulate the geometrical shape, stresses, and strains resulting from the hydroforming operations performed to the pre-bent and pre-formed raw material 104 according to the object design 212.

At operation 312, the FEA simulator 204 provides the simulated results 214. For example, the FEA simulator 204 may provide simulated results 214 indicative of the simulated stresses resulting from the manufacturing process to the display 216 and/or to the storage 210. The simulated results 214 may indicate various aspects of the feasibility of the object design 212 for the object being simulated, such as whether the resulting object confirms with maximum plastic deformation limits of the raw material 104, or whether the resulting object suffers from formation of excessive wrinkles, issues with splitting, or otherwise includes portions areas suffering from form and position tolerances in excess of various design requirements. After operation 312, the process 300 ends.

Thus, by resetting the stress tensor of the intermediate simulated results after the pre-bend operation to account for overbending fine-tuning performed by the bender operator, the FEA simulator 204 may be configured to more accurately simulate the geometrical shape, post-hydroform springback and strain and stress distributions in the actual manufactured part without the need to develop a springback compensated bend schedule, and performing an additional post-bending springback simulation step in FEA. While many of the examples discloses herein relate to hydroforming, it should be noted that the aforementioned techniques are applicable to other types of FEA simulation of metal forming having simulated bends followed by further operations, such as bending followed by pressing, shear forming, or sandblasting.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a memory storing a finite-element-analysis simulator; and
a processor configured to execute the finite-element-analysis simulator to
simulate a pre-bend operation of an object design, performed to a raw material in forming an object, to produce simulated pre-bend results,
adjust stress tensor components of the simulated pre-bend results to eliminate residual elastic deformation from the simulated pre-bend results, and
complete object simulation of the raw material using the adjusted simulated pre-bend results.

2. The system of claim 1, wherein the raw material is at least one of a tubular ductile metal and a shaped extrusion.

3. The system of claim 1, wherein the processor is further configured to execute the finite-element-analysis simulator to:
simulate a pre-forming operation of the object design according to the adjusted simulated pre-bend results to produce simulated pre-forming results; and
simulate a hydroforming operation of the object design according to the simulated pre-forming results to produce simulated hydroforming results.

4. The system of claim 1, wherein the processor is further configured to execute the finite-element-analysis simulator to simulate a hydroforming operation of the object design according to the adjusted simulated pre-bend results to produce simulated hydroforming results.

5. The system of claim 1, wherein the processor is further configured to execute the finite-element-analysis simulator to:
discretize a geometry of the object into a set of finite element nodes connected together as a mesh approximating the geometry of the object;
simulate the pre-bend operation to produce simulated pre-bend results for each of the set of finite elements; and
adjust stress tensor components of the simulated pre-bend results associated with each of the finite elements to eliminate the residual elastic deformation from the simulated pre-bend results.

6. The system of claim 1, wherein the processor is further configured to execute the finite-element-analysis simulator to eliminate the residual elastic deformation from the simulated pre-bend results by resetting the stress tensor components of the simulated pre-bend results to a substantially negligible amount of stress.

7. The system of claim 6, wherein the substantially negligible amount of stress is zero.

8. The system of claim 6, wherein the substantially negligible amount of stress is reset in conformance with adjustments made to an amount of overbending performed during manufacture of the object from the raw material.

9. A computer-implemented method comprising:
simulating, by a hydroforming simulator of raw materials executed by a processing device, a pre-bend operation of an object design performed to a raw material in forming an object, to produce simulated pre-bend results;
adjusting, by the hydroforming simulator, stress tensor components of the simulated pre-bend results to eliminate residual elastic deformation from the simulated pre-bend results; and
completing the hydroforming simulation using the adjusted simulated pre-bend results.

10. The method of claim 9, further comprising:
simulating a pre-forming operation of the object design according to the adjusted simulated pre-bend results to produce simulated pre-forming results; and
simulating a hydroforming operation of the object design according to the simulated pre-forming results to produce simulated hydroforming results.

11. The method of claim 9, further comprising:
discretizing a geometry of the object into a set of finite element nodes connected together as a mesh approximating the geometry of the object;
simulating the pre-bend operation to produce simulated pre-bend results for each of the set of finite elements; and
adjusting stress tensor components of the simulated pre-bend results associated with each of the finite elements to eliminate residual elastic deformation from the simulated pre-bend results.

12. The method of claim 9, further comprising executing the hydroforming simulator to eliminate residual elastic deformation from the simulated pre-bend results by resetting the stress tensor components of the simulated pre-bend results to a substantially negligible amount of stress.

13. The method of claim 12, wherein the substantially negligible amount of stress is zero.

14. The method of claim 12, wherein the substantially negligible amount of stress is reset in conformance with adjustments made to an amount of overbending performed during manufacture of the object from the raw material that is outside the object design of the object.

15. A non-transitory computer-readable medium storing instructions of a finite-element-analysis simulator, that, when executed by at least one processor, are configured to cause the at least one processor to:
simulate a pre-bend operation of an object design performed to a raw material in forming an object, to produce simulated pre-bend results;
adjust, by the finite-element-analysis simulator, stress tensor components of the simulated pre-bend results to eliminate residual elastic deformation from the simulated pre-bend results; and
complete the finite-element-analysis simulation using the adjusted simulated pre-bend results.

16. The medium of claim 15, further storing instructions configured to cause the at least one processor to:
simulate a pre-forming operation of the object design according to the adjusted simulated pre-bend results to produce simulated pre-forming results; and
simulate a hydroforming operation of the object design according to the simulated pre-forming results to produce simulated hydroforming results.

17. The medium of claim 15, further storing instructions configured to cause the at least one processor to:
discretize a geometry of the object into a set of finite element nodes connected together as a mesh approximating the geometry of the object;
simulate the pre-bend operation to produce simulated pre-bend results for each of the set of finite element nodes; and
adjust stress tensor components of the simulated pre-bend results associated with each of the finite elements to eliminate residual elastic deformation from the simulated pre-bend results.

18. The medium of claim 15, further storing instructions configured to cause the at least one processor to eliminate residual elastic deformation from the simulated pre-bend results by resetting the stress tensor components of the simulated pre-bend results to a substantially negligible amount of stress.

19. The medium of claim 18, wherein the substantially negligible amount of stress is zero.

20. The medium of claim 18, wherein the substantially negligible amount of stress is reset in conformance with adjustments made to an amount of overbending performed during manufacture of the object from the raw material that is outside the object design of the object.
